(19) United States
(12) Patent Application Publication
(10) Pub. No.: US 2025/0390225 A1
(43) Pub. Date: Dec. 25, 2025

(54) METHOD AND NON-TRANSITORY COMPUTER-READABLE STORAGE MEDIUM AND APPARATUS FOR ACCELERATING EXECUTION OF HOST READ COMMANDS

(71) Applicant: Silicon Motion, Inc., Zhubei City (TW)

(72) Inventor: Yu-Ting CHEN, New Taipei City (TW)

(73) Assignee: Silicon Motion, Inc., Zhubei City (TW)

(21) Appl. No.: 19/028,056

(22) Filed: Jan. 17, 2025

(30) Foreign Application Priority Data
Jun. 20, 2024 (CN) 202410797594.7

(51) Int. Cl. G06F 3/06

(52) U.S. Cl. CPC G06F 3/0613; G06F 3/0659; G06F 3/0679

(57) ABSTRACT

The invention is related to a method, performed by a processing unit, includes: obtaining a group number and a section number associated with a logical address carried in a host read command; determining whether a variable corresponding to a first mode is lower than or equal to an accumulation threshold; performing operations of the first mode for reading first records associated with the group number and the section number from a host-address to flash-address mapping (H2F) table in a flash module, and second records being located after the first records, and storing them in a random access memory (RAM) when the variable is lower than or equal to the accumulation threshold; performing operations of a second mode for reading the first records from the H2F table in the flash module only, and storing them in the RAM when the variable is higher than the accumulation threshold.

### CROSS-REFERENCE TO RELATED APPLICATIONS

This application claims the benefit of priority to Patent Application No. 202410797594.7, filed in China on Jun. 20, 2024; the entirety of which is incorporated herein by reference for all purposes.

### BACKGROUND

The disclosure generally relates to storage devices and, more particularly, to a method, a non-transitory computer-readable storage medium and an apparatus for accelerating execution of host read commands.

Flash memory devices typically include NOR flash devices and NAND flash devices. NOR flash devices are random access—a host side accessing a NOR flash device can provide the device any address on its address pins and immediately retrieve data stored in that address on the device's data pins. NAND flash devices, on the other hand, are not random access but serial access. It is not possible for NAND to access any random address in the way described above. Instead, the host side has to write into the device a sequence of bytes which identifies both the type of command requested (e.g. read, write, erase, etc.) and the address to be used for that command. The address identifies a page (the smallest chunk of flash memory that can be written in a single operation) or a block (the smallest chunk of flash memory that can be erased in a single operation), and not a single byte or word. Efficient execution of host read commands has always been an important issue for NAND flash devices.

### SUMMARY

In an aspect of the invention, an embodiment introduces a method for accelerating execution of host read commands, performed by a processing unit, to include the following steps: obtaining a group number and a section number associated with a logical address carried in a host read command; determining whether a variable corresponding to a first mode is lower than or equal to an accumulation threshold; performing operations of the first mode for reading first records associated with the group number and the section number from a host-address to flash-address mapping (H2F) table in a flash module, and second records being located after the first records, and storing the first records and the second records in a random access memory (RAM) when the variable corresponding to the first mode is lower than or equal to the accumulation threshold; performing operations of a second mode for reading the first records from the H2F table in the flash module only, and storing the first records in the RAM when the variable corresponding to the first mode is higher than the accumulation threshold.

The variable corresponding to the first mode stores a total number that mapping records temporarily stored in the RAM are judged as a low-usage state during the first mode. The first records store mapping information about which physical address where user data associated with each of first logical addresses is actually stored in an order of the first logical addresses. The second records store mapping information about which physical address where user data associated with each of second logical addresses is actually stored in an order of the second logical addresses.

In another aspect of the invention, an embodiment introduces a non-transitory computer-readable storage medium having stored therein program code that, when loaded and executed by a processing unit, causes the processing unit to perform the method for accelerating execution of host read commands as described above.

In still another aspect of the invention, an embodiment introduces an apparatus for accelerating execution of host read commands, to include: a flash interface (I/F), coupled to a flash module; and a processing unit, coupled to the flash I/F. The flash module is arranged operably to: store an H2F table. The H2F table includes groups, each group includes sections, each section includes records, and each record stores mapping information about which physical address where user data associated with each of logical addresses is actually stored in an order of the logical addresses. The processing unit is arranged operably to: obtain a group number and a section number associated with a logical address carried in a host read command; determine whether a variable corresponding to a first mode is less than or equal to an accumulation threshold; when the variable is less than or equal to the accumulation threshold, perform operations of the first mode for driving the flash I/F to read first records associated with the first group number and the first section number, and second records, which is located after the first records, associated with the first group number and a second section number from the H2F table in the flash module, and storing the first records and the second records in the RAM; and when the variable is greater than the accumulation threshold, perform operations of a second mode for driving the flash I/F to read the first records associated with the first group number and the first section number from the H2F table in the flash module, and storing the first records in the RAM.

Both the foregoing general description and the following detailed description are examples and explanatory only, and are not restrictive of the invention as claimed.

### BRIEF DESCRIPTION OF THE DRAWINGS

FIG. 1 is the system architecture of an electronic apparatus according to an embodiment of the invention.

FIG. 2 is a schematic diagram illustrating a flash module according to an embodiment of the invention.

FIG. 3 is a schematic diagram showing the hardware architecture of a portion of a NAND flash unit according to an embodiment of the invention.

FIG. 4 is a schematic diagram showing the relationships between the high-level mapping table and groups of the host-address to flash-address mapping (H2F) table according to an embodiment of the invention.

FIG. 5 is a schematic diagram showing the relationships between one record of the group and the physical page of the flash module according to an embodiment of the invention.

FIG. 6 is a schematic diagram of the mode switch according to an embodiment of the invention.

FIG. 7 is a flowchart illustrating a method for selecting the mapping read mode according to an embodiment of the invention.

FIG. 8 is a flowchart illustrating a method for performing the operations of the group-mapping read mode according to an embodiment of the invention.

FIG. 9 is a flowchart illustrating a method for performing the operations of the section-mapping read mode according to an embodiment of the invention.

### DETAILED DESCRIPTION

Reference is made in detail to embodiments of the invention, which are illustrated in the accompanying drawings. The same reference numbers may be used throughout the drawings to refer to the same or like parts, components, or operations.

Certain aspects and embodiments of this disclosure are provided below. Some of these embodiments may be applied independently and some of them may be applied in conjunction as would be apparent to those of skill in the art. In the following description, for the purposes of explanation, specific details are set forth in order to provide a thorough understanding of aspects of the application. However, it will be apparent that various embodiments may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that changes may be made in the function and arrangement of elements without departing from the spirit and scope of the application as set forth in the claims.

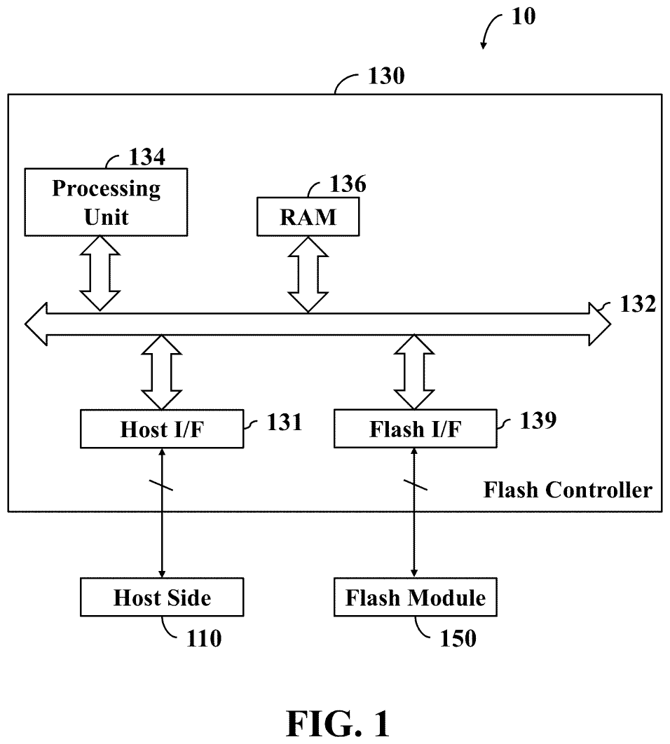

Refer to FIG. 1. The electronic apparatus 100 includes the host side 110, the flash controller 130 and the flash module 150, and the flash controller 130 and the flash module 150 may be collectively referred to as a device side. The electronic apparatus 100 may be practiced in an external storage drive, a Personal Computer (PC), a laptop PC, a tablet PC, a mobile phone, a digital camera, a digital recorder, a smart television, a smart freezer, an automotive electronics system or other consumer electronic products. The host side 110 and the host interface (I/F) 131 of the flash controller 130 may communicate with each other by Universal Serial Bus (USB), Advanced Technology Attachment (ATA), Serial Advanced Technology Attachment (SATA), Peripheral Component Interconnect Express (PCI-E), Universal Flash Storage (UFS), Embedded Multi-Media Card (eMMC) protocol, or others. The flash I/F 139 of the flash controller 130 and the flash module 150 may communicate with each other by a Double Data Rate (DDR) protocol, such as Open NAND Flash Interface (ONFI), DDR Toggle, or others. The flash controller 130 includes the processing unit 134 and the processing unit 134 may be implemented in numerous ways, such as with general-purpose hardware (e.g., a microcontroller unit, a single processor, multiple processors or graphics processing units capable of parallel computations, or others) that is programmed using firmware and/or software instructions to perform the functions recited herein. The processing unit 134 may receive host commands from the host side 110 through the host interface (I/F) 131, such as write commands, read commands, discard commands, erase commands, etc., schedule and execute the host commands. The flash controller 130 includes the Random Access Memory (RAM) 136, which may be implemented in a Dynamic Random Access Memory (DRAM). a Static Random Access Memory (SRAM), or the combination thereof, for allocating space as a data buffer storing user data (also referred to as host data) that has been obtained from the host side 110 and is to be programmed into the flash module 150, and that has been read from the flash module 150 and is to be output to the host side 110. The RAM 136 stores necessary data in execution, such as variables, data tables, data abstracts, host-address to flash-address mapping (H2F) tables. flash-address to host-address mapping (F2H) tables, or others. The flash I/F 139 includes a NAND flash controller (NFC) to provide functions that are required to access to the flash module 150, such as a command sequencer, a Low Density Parity Check (LDPC) encoder/decoder, etc.

The flash controller 130 may be equipped with the bus architecture 132 to couple components to each other to transmit data, addresses, control signals, etc. The components include but not limited to the host I/F 131, the processing unit 134, the RAM 136 and the flash I/F 139. A direct memory access (DMA) circuitry of a component moves data between specific components through the bus architecture 132 according to instructions or control signals. For example, a DMA circuitry of the host I/F 131 or the flash I/F 139 may migrate data in a specific data buffer thereof to a specific address of the RAM 136, migrate data in a specific address of the RAM 136 to a specific data buffer thereof, and so on.

The flash module 150 provides huge storage space typically in hundred Gigabytes (GBs), or even several Terabytes (TBs), for storing a wide range of user data, such as high-resolution images, video files, etc. The flash module 150 includes control circuitries and memory arrays containing memory cells, such as being configured as Single Level Cells (SLCs), Multi-Level Cells (MLCs), Triple Level Cells (TLCs), Quad-Level Cells (QLCs), or any combinations thereof. The processing unit 134 programs user data into a designated address (a destination address) of the flash module 150 and reads user data from a designated address (a source address) thereof through the flash I/F 139. The flash I/F 139 may use several electronic signals including a data line, a clock signal line and control signal lines for coordinating the command, address and data transfer with the flash module 150. The data line may be used to transfer commands, addresses, read data and data to be programmed; and the control signal lines may be used to transfer control signals, such as Chip Enable (CE), Address Latch Enable (ALE), Command Latch Enable (CLE), Write Enable (WE), etc.

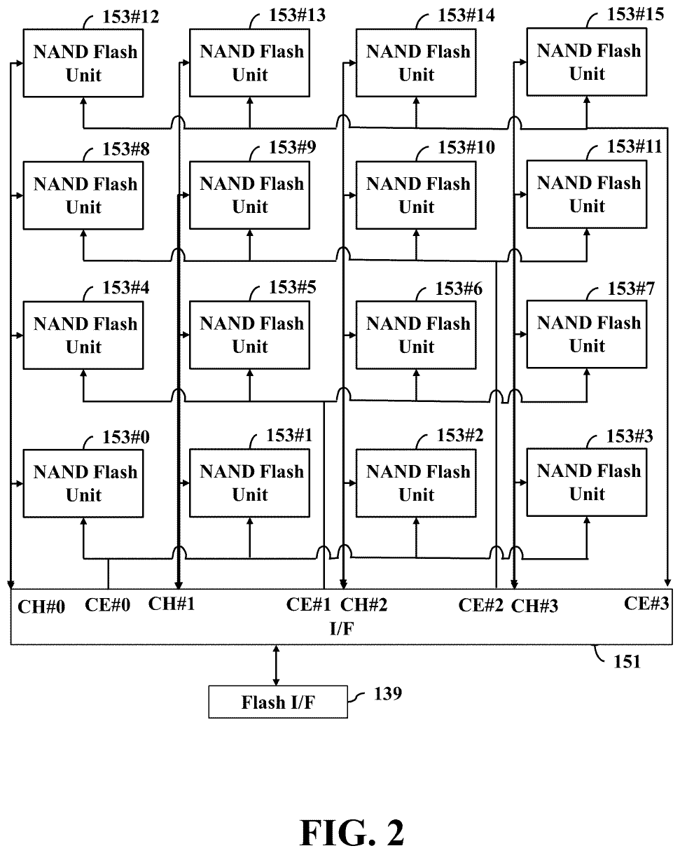

Refer to FIG. 2. The I/F 151 of the flash module 150 may include four I/O channels (hereinafter referred to as channels) CH #0 to CH #3 and each is connected to four NAND flash units, for example, the channel CH #0 is connected to the NAND flash units 150 #0, 150 #4, 150 #8 and 150 #12. Each NAND flash unit can be packaged in an independent die. The flash I/F 139 may issue one of the CE signals CE #0 to CE #3 through the I/F 151 to activate the NAND flash units 153 #0 to 153 #3, the NAND flash units 153 #4 to 153 #7, the NAND flash units 153 #8 to 153 #11, or the NAND flash units 153 #12 to 153 #15, and read data from or program data into the activated NAND flash units in parallel.

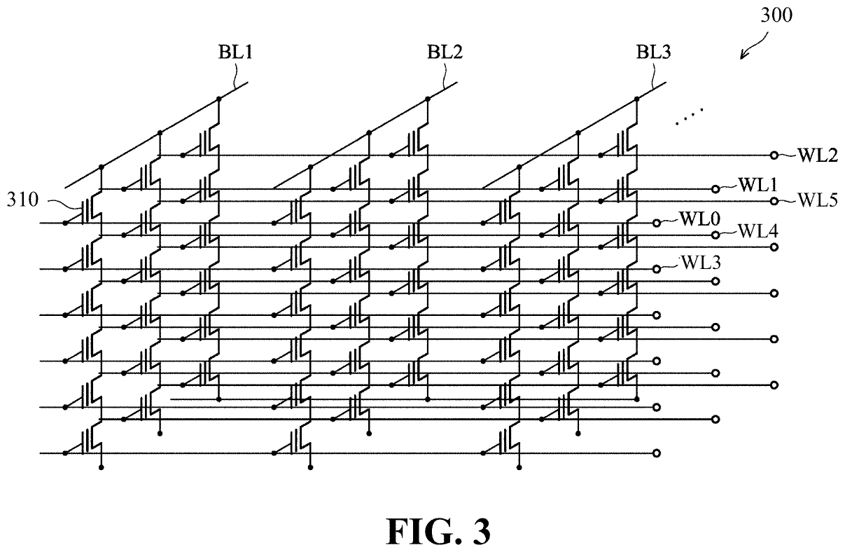

Refer to FIG. 3 showing the hardware architecture of a portion of a NAND flash unit. Each NAND flash unit may contain a plurality of memory blocks (e.g. the memory block 300) and the memory block 300 contains multiple memory units, such as floating gate transistors (e.g. the floating gate transistor 310), or other charge trap devices. The structure of the memory block 300 includes bit lines and word lines. For brevity, only the bit lines BL1 to BL3 and the word lines WL0 to WL5 are labeled in FIG. 3. For example, the floating gate transistors on each of word lines WL0 to WL5 form pages for storing data.

Each NAND flash unit may include multiple data planes, each data plane may include multiple physical blocks. In order to improve the data programming and data reading efficiency, designated physical blocks of the data planes in multiple NAND flash units are organized into one super block (SB), so that each SB contains multiple physical pages. The SB and the physical page are identified by a super-block number and a page number, respectively, and the combination is referred to as a physical address of the flash module 150.

Each SB is labeled as a data block or a current block according to its function. The processing unit 134 may select an empty SB as the current block for preparing to program user data received from the host side 110. In order to improve the efficiency of data programming, the user data provided by the host side 110 is programmed in parallel into designated physical blocks of the SB across multiple NAND flash units. The processing unit 134 maintains the F2H table for each current block. Each F2H table contains multiple records. Each record stores the information indicating which logical address of user data that is associated with (or mapped by) each physical page in the current block. The records in the F2H table are stored in the order of the page numbers of physical pages in the current block. The logical address may be expressed in a logical block address (LBA), a host page number or other expression and is managed by the host side 110. For example, each LBA is associated with 512 bytes (B) of user data and each host page number is associated with 4 kilobytes (KB) of user data. The processing unit 134 may drive the flash I/F 139 to program the corresponding F2H table in the RAM 136 into the data region of the designated physical page (for example, the last physical page) of one current block after all physical pages of this current block are fully stored in user data or the remaining physical pages of this current block are filled with dummy values. The current block is changed to the data block after the corresponding F2H table has been programmed into the flash module 150, and the user data stored in the data block cannot be modified. Subsequently, the processing unit 134 selects another empty SB as a new current block.

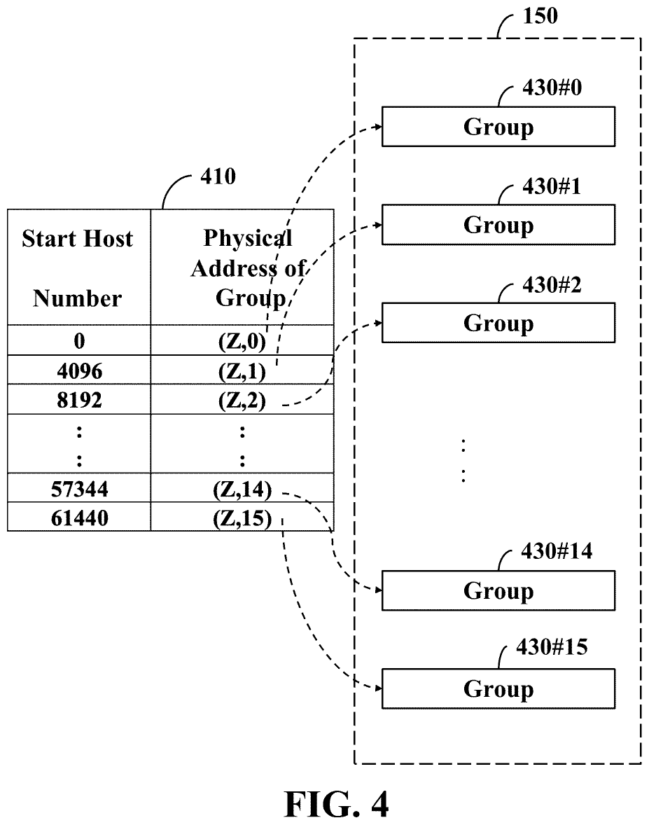

In addition to programming the F2H table into the designated physical page in the current block, the processing unit 134 further needs to update the H2F table based on the F2H table of the current block, so that when a host read command is executed in the future, the processing unit 134 can quickly find information about which physical address where user data associated with a specific logical address is actually stored by searching the H2F table. The H2F table includes multiple records, which store the information about which physical address where user data associated with each logical address is actually stored in the order of logical addresses. However, since the RAM 136 does not provide enough space to store the whole H2F table for quick search of the physical addresses in the data read operations by the processing unit 134, the whole H2F table is divided into multiple groups, where each group includes multiple sections and each section includes a fixed number of records. For example, each group includes 16 sections, each section includes 256 records, and each record stores mapping information about which physical address where user data associated with a specific logical address is actually stored in the flash module 150. Records of an entire group are stored at consecutive physical addresses in the flash module 150, so that records of specific sections in the group can be read from the flash module 150 and stored in the RAM 136 during future data read operations. Each group can also be referred to as a reading retire mapping table. Refer to FIG. 4, the whole H2F table is divided into groups 430 #0 to 430 #15. The processing unit 134 further maintains the high-level mapping table including multiple records, which store the information about which physical address where user data associated with a logical address range in each group is actually stored in the order of logical addresses. For example, the group 430 #0 associated with the 0^{th} to the 4095^{th} host pages is stored in the Oth physical page of a specific SB (the letter “Z” as shown in FIG. 4 represents an SB number), the group 430 #1 associated with the 4096^{th} to the 8191^{th} host pages is stored in the 1^{st} physical page of the specific SB, and so on. Although sixteen groups are shown in FIG. 4, those skilled in the art can divide the whole H2F table into more or less groups depending on the capacity of the flash module 150, and the invention should not be limited thereto.

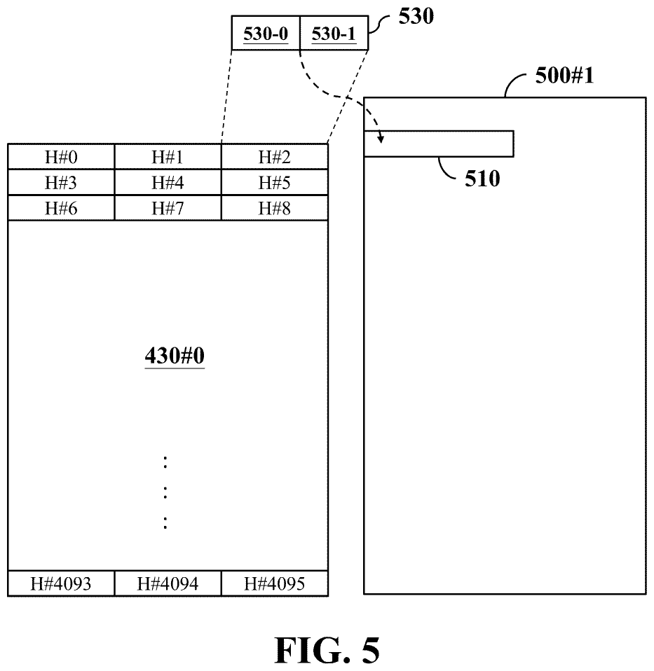

For example, space required for each group is 16 KB. Refer to FIG. 5. The group 430 #0 stores the information about the physical addresses mapped by the host page numbers according to the ascending order of the host page numbers in the corresponding logical address range. In alternative embodiments, the logical addresses are expressed by LBA numbers and each LBA number maps to user data of 512 B, and the invention should not be limited thereto. For example, the group 430 #0 stores physical-address information of H #0 to H #4095 sequentially. The physical-address information 530 is represented in four bytes: the first two bytes 530-0 record the SB number; the last two bytes 530-1 record the physical page number. For example, the physical-address information 530 corresponding to the host page H #2 points to the physical page 510 in the SB 500 #1. The bytes 530-0 record the number of the SB 500 #1 and the bytes 530-1 record the number of the physical page 510.

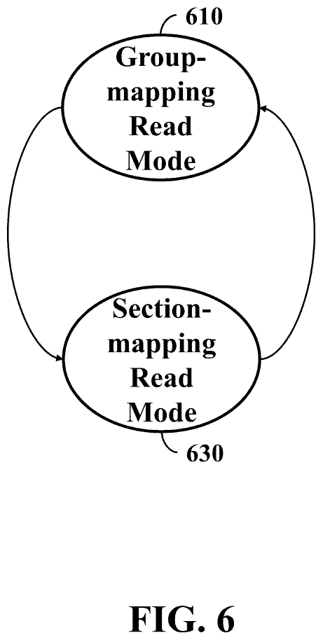

Refer to FIG. 6. In some implementations, in order to improve the execution performance for host read commands, reading of the H2F table including two modes: group-mapping read mode 610; and section-mapping read mode 630. The processing unit 134 when receiving a host read command indicating that the length of read user data is greater than or equal to 256 KB enters the group-mapping read mode 610 for obtaining the specific group associated with the logical addresses of the user data to be read, driving the flash I/F 139 to read the records of multiple sections in this group, and storing the records of the sections in the RAM 136 for a fast lookup of future host read commands. The processing unit 134 when receiving a host read command indicating that the length of read user data is less than 256 KB enters the section-mapping read mode 630 for obtaining the specific section in the specific group associated with the logical address(es) of the user data to be read, driving the flash I/F 139 to read the records (e.g. in 1 KB) of this section in this group, and storing the records of this section in the RAM 136 for a fast lookup of future host read commands. However, when the host side 110 issues multiple random read commands but each random read command indicates that the length of user data to be read is greater than or equal to 256 KB (that is, the logical addresses of user data to be read, which are indicated by these host read commands do not fallen into the same group), the processing unit 134 mistakenly enters the group-mapping read mode 610, so that the processing unit 134 wastes time and the computing resources to read the records of the sections that will not be used from the H2F table in the flash module 150, and reduces the execution performance of the host read commands.

In order to alleviate the drawbacks caused by the implementations as described above, an embodiment of the invention proposes to decide to enter the group-mapping read mode 610 or the section-mapping read mode 630 is entered additionally based on the past hits of the records of the H2F table temporarily stored in the RAM 136. Compared with the implementations that only considers the length of the user data read as instructed in the host read command, an embodiment of the invention further considers the actual hists of the records of the H2F table temporarily stored in the RAM 136, which would avoid to waste time and the computing resources to read the records of the sections that will not be used from the H2F table in the flash module 150 during the execution of random read commands for long data. The processing unit 134 enters the group-mapping read mode 610 to read the H2F table when the device side initiates.

In an aspect of the invention, the processing unit 134 divides successive host read commands into different batches according to the group associated with the records that are latest stored in the RAM 136, thereby when all host read commands in each batch are processed, the group in the RAM 136, which the host read commands corresponds, is the same. For example, since the groups associated with the latest records in the RAM 136 when five successive host read commands are processed are groups 430 #1, 430 #1, 430 #1, 430 #2 and 430 #2, respectively, the processing unit 134 makes the first to third host read commands to form one batch and the fourth to fifth host read commands to form another batch. No matter which mode the processing unit 134 is in, in each batch, the processing unit 134 updates the information of the past hits for the host read commands, for example, calculates the hit ratio indicating that the mapping information associated with the logical addresses carried in the host read commands in this batch has been stored in the RAM 136. In the group-mapping read mode 610, the processing unit 134, at the beginning of each batch, determines whether to increase the number of the low-usage state of the group-mapping read mode 610 by 1 according to the information of the past hits in the previous batch. In the section-mapping read mode 630, the processing unit 134, at the beginning of each batch, determines whether to increase the number of the high-usage state of the section-mapping read mode 610 by 1 according to the information of the past hits in the previous batch.

In an aspect of the invention, the processing unit 134 predicts whether sequential read commands or random read commands are formed by consecutive host read commands that will be issued by the host side 110 according to the number of the low-usage state of the group-mapping read mode 610 and the number of the high-usage state of the section-mapping read mode 630. If the processing unit 134 predicts the forthcoming host read commands will form the sequential read commands, then the group-mapping read mode 610 is entered. If the processing unit 134 predicts the forthcoming host read commands will form the random read commands, then the section-mapping read mode 630 is entered.

In an aspect of the invention, the processing unit 134 obtains a group number and a first section number associated with a logical address carried in a first host read command, and determines whether a variable associated with a first mode (e.g. the group-mapping read mode 610) is less than or equal to the accumulation threshold, in which the variable stores a total number that the mapping records temporarily stored in the RAM 136 are judged as the low-usage state during the first mode. If so, the processing unit 134 performs the operations of the first mode for reading first records associated with the group number and the first section number and second records associated with the group number and a second section number from the H2F table in the flash module 150 and storing the first records and the second records in the RAM 136, where the second records are located after the first records in the same group. Otherwise, the processing unit 134 performs the operations of a second mode (e.g. the section-mapping read mode 630) for reading the first records associated with the group number and the first section number from the H2F table in the flash module 150 and storing the first records in the RAM 136. Subsequently, the processing unit 134 obtains a physical address mapped from the logical address from the record in the RAM 136, reads user data of the logical address from the physical address of the flash module 150; and replies with the user data to the host side 110.

Specifically, when the flash controller 130 initiates, the RAM 136 does not store any record in the H2F table temporarily, and the processing unit 134 sets the variables “UsageLowerCnt”, “UsageHigherCnt”, “ReadSec_A”, “Usage_A”, “ReadSec_B” and “Usage_B” to 0 and sets the variables “Grp_A” and “Grp_B” to the initial values (e.g. “0xffff”). The variable “UsageLowerCnt” is used to store the count that the mapping records temporarily stored in the RAM 136 are determined to be low-usage when the group-mapping read mode 610 is entered. The variable “UsageHigherCnt” is used to store the count that the mapping records temporarily stored in the RAM 136 are determined to be high-usage when the section-mapping read mode 630 is entered. The variable “ReadSec_A” is used to store a total number of record(s) that is (are) read from the flash module 150 in one batch in the group-mapping read mode 610. The variable “Usage_A” is used to store the count that the logical address(es) carried in one or more host read commands in one batch hit the records of the group temporarily stored in the RAM 136 when the group-mapping read mode 610 is entered. The variable “ReadSec_B” is used to store a total number of record(s) that is (arc) read from the flash module 150 in one batch in the section-mapping read mode 630. The variable “Usage_B” is used to store the count that the logical address(es) carried in one or more host read commands in one batch hit the records of the group temporarily stored in the RAM 136 when the section-mapping read mode 630 is entered. The variable “Grp_A” is used to store the group number associated with the latest record temporarily stored in the RAM 136 when the group-mapping read mode 610 is entered. The variable “Grp_B” is used to store the group number associated with the latest record temporarily stored in the RAM 136 when the section-mapping read mode 630 is entered.

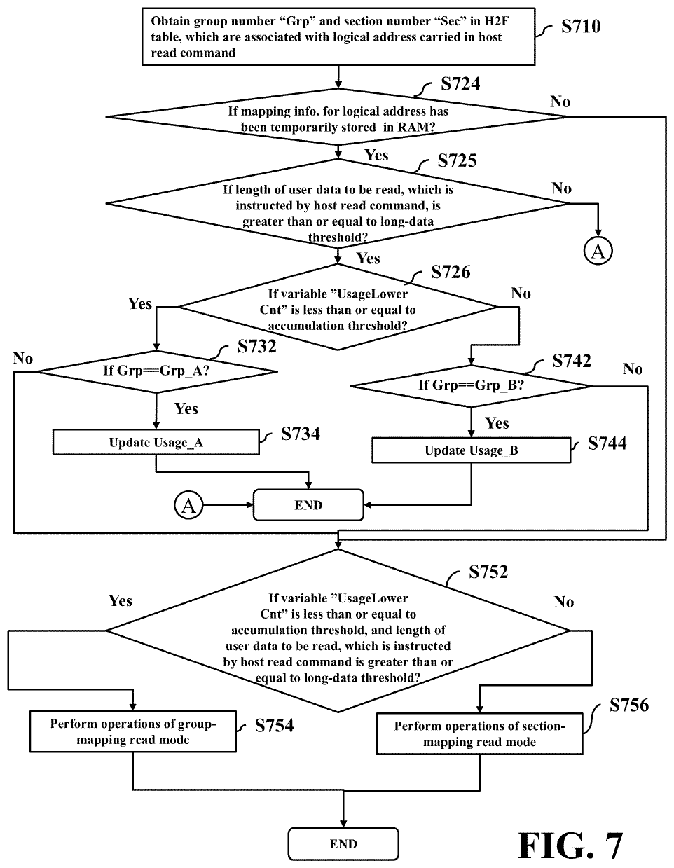

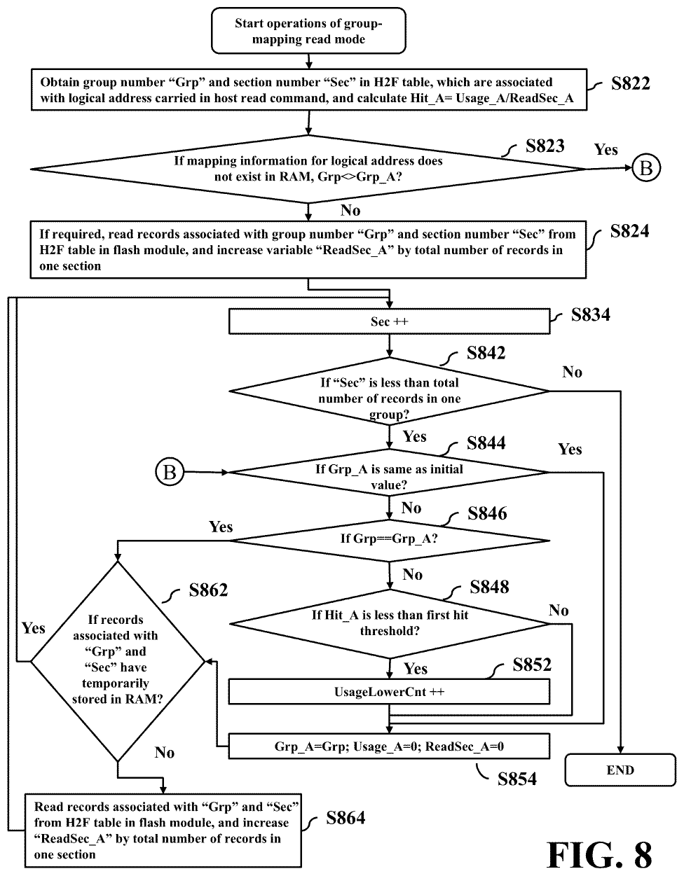

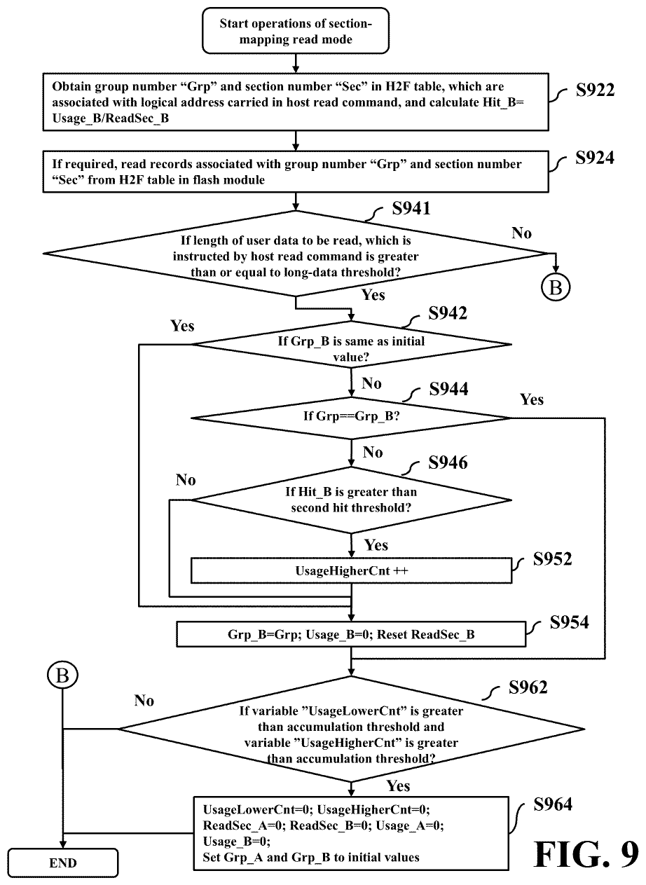

Each time a host read command is received from the host side 110 through the host I/F 131, the processing unit 134 determines to perform the operations of the group-mapping read mode 610 or the section-mapping read mode 630 for updating the records of the H2F table temporarily stored in the RAM 136 according to the actual past hits for the records of the H2F table temporarily stored in the RAM 136. FIG. 7 shows a method for performing the operations of the group-mapping read mode 610 or the section-mapping read mode 630 by the processing unit 134 when loading and executing program codes of the Firmware Translation Layer (FTL) for the newly received host read command. The details are described as follows:
Step S710: The group number “Grp” and the section number “Sec” in the H2F table, which are associated with a logical address carried in a host read command, are obtained. Assume that the logical address carried in the host read command is the host page number “Hpage”, each group includes sixteen sections and each section includes mapping records for 256 host pages: The group number “Grp” and the section number “Sec” are calculated by the following equations:

$$Sec = ( Hpage ≫ 0 x 8 ) \& 0 xf$$

$$Grp = Hpage ≫ 0 xc$$

where the symbol “>>” represents the logical right shift operation. It is noted that the group number “Grp” and the section number “Sec” indicates the specific section in the specific group of the H2F table.
Step S724: It is determined whether the mapping information (that is, the mapped physical address) for the logical address carried in the host read command is stored in the RAM 136. If so, it means that the mapping information for this logical address has been temporarily stored in the RAM 136 and the process proceeds to step S725. Otherwise, the process proceeds to step S752.
Step S725: It is determined whether the length of user data to be read, which is instructed by the host read command, is greater than or equal to the long-data threshold. If so, it means that the records of one or more sections of the H2F table in the flash module 150 need to be temporarily stored in the RAM 136 and the process proceeds to step S726. Otherwise, the whole process ends.
Step S726: It is determined whether the variable “UsageLowerCnt” is less than or equal to the accumulation threshold, which can be set to an arbitrary integer greater than 0. In some embodiments, the accumulation threshold is set to 3. If so, it means that the reading for the H2F table is in the group-mapping read mode 610 currently and the process proceeds to step S732. Otherwise, it means that the reading for the H2F table is in the section-mapping read mode 630 and the process proceeds to step S742.
Step S732: It is determined whether the group number “Grp” is equal to the variable “Grp_A”. If so, it means that the group associated with the logical address(es) carried in the host read command is the same as the group associated with the latest record temporarily stored in the RAM 136 and the process proceeds to step S734. Otherwise, the process proceeds to step S752.
Step S734: The variable “Usage_A” is updated to indicate the accumulated number that the logical addresses carried in (the previous host read command(s) and) the current host read command have hit the records of the H2F table temporarily stored in the RAM 136 in one batch in the group-mapping read mode 610. For example, the variable “Usage_A” is increased by 200 when the logical addresses carried in the host read command hit 200 records temporarily stored in the RAM 136.
Step S742: It is determined whether the group number “Grp” is equal to the variable “Grp_B”. If so, it means that the group associated with the logical address(es) carried in the host read command is the same as the group associated with the latest record temporarily stored in the RAM 136 and the process proceeds to step S744. Otherwise, the process proceeds to step S752.
Step S744: The variable “Usage_B” is updated to indicate the accumulated number that the logical addresses carried in (the previous host read command(s) and) the current host read command have hit the records of the H2F table temporarily stored in the RAM 136 in one batch in the section-mapping read mode 630. For example, the variable “Usage_B” is increased by 100 when the logical addresses carried in the host read command hit 100 records temporarily stored in the RAM 136.
Step S752: It is determined whether the variable “UsageLowerCnt” is less than or equal to the accumulation threshold, and whether the length of user data to be read, which is instructed by the host read command, is greater than or equal to the long-data threshold. If both are true, it means that the reading for the H2F table is in the group-mapping read mode 610 and the process proceeds to step S754. Otherwise, it means that the reading for the H2F table is in the section-mapping read mode 630 and the process proceeds to step S756. In alternative embodiments, step S752 is devised to determine whether the variable “UsageLowerCnt” is less than or equal to the accumulation threshold only.
Step S754: Operations of the group-mapping read mode 610 are performed. The details are referred to the descriptions of FIG. 8 as follows.
Step S756: Operations of the section-mapping read mode 630 are performed. The details are referred to the descriptions of FIG. 9 as follows.

FIG. 8 shows a method for performing the operations of the group-mapping read mode 610 by the processing unit 134 when loading and executing program code of the FTL. The details are described as follows:
Step S822: The group number “Grp” and the section number “Sec” in the H2F table, which are associated with the logical address carried in the host read command, are obtained, and Hit_A=Usage_A/ReadSec_A is calculated, where the variable “Hit_A” is used to store the actual hits in this batch. A portion of the details of this step is similar to that of step S710, and is omitted herein for brevity.
Step S823: It is determined whether the mapping information for this logical address does not exist in the RAM 136, and whether the group number “Grp” is different from the variable “Grp_A”. If both are true, the process proceeds to step S844. Otherwise, the process proceeds to step S824.
Step S824: If the records associated with the group number “Grp” and the section number “Sec” do not exist in the RAM 136, the flash I/F 139 is driven to read the records associated with the group number “Grp” and the section number “Sec” from the H2F table in the flash module 150, and the records are stored in the designated address of the RAM 136. In addition, the variable “ReadSec_A” is increased by a total number of records in one section. For example, if a total number of records in one section is 256, then the variable “ReadSec_A” is increased by 256. It is noted that since only fixed space can be allocated in the RAM 136 to store records of the H2F table, when the allocated space is fully of records, the newly read record overwrites the earliest record stored in the RAM 136.
Step S834: The section number “Sec” in increased by 1.
Step S842: It is determined whether the section number “Sec” is less than a total number of records in one group. If so, the process proceeds to step S844. Otherwise, it means that the records of the last section in this group have been stored in the RAM 136 and the entire process ends.
Step S844: It is determined whether the variable “Grp_A” is the same as the initial value. If so, the process proceeds to step S854. Otherwise, the process proceeds to step S846.
Step S846: It is determined whether the group number “Grp” is the same as the variable “Grp_A”. If so, it means that the group associated with the logical address(es) carried in the host read command is the same as the group associated with the latest record temporarily stored in the RAM 136, and the process proceeds to step S862. Otherwise, it means that the group associated with the logical address(es) carried in the host read command is different from the group associated with the latest record temporarily stored in the RAM 136 (that is, changing to a new group), and the process proceeds to step S848.
Step S848: It is determined whether the variable “Hit_A” is less than the first hit threshold, where the first hit threshold can be set to an arbitrary value ranging from 0.6 to 0.9. In some embodiments, the first hit threshold is set to 0.7. If so, it means that the ratio indicating that the logical addresses carried in the host read commands in the previous batch hit the records temporarily stored in the RAM 136 does not meet the expectation (that is, the records temporarily stored in the RAM 136 are judged as the low-usage state), and the process proceeds to step S852. Otherwise, it means that the ratio indicating that the logical addresses carried in the host read commands in the previous batch hit the records temporarily stored in the RAM 136 meets the expectation (that is, the records temporarily stored in the RAM 136 are judged as the high-usage state), and the process proceeds to step S854.
Step S852: The variable “UsageLowerCnt” is increased by 1.
Step S854: The variable “Grp_A” is set to the group number “Grp”, the variable “Usage_A” is set to 0, and the variable “ReadSec_A” is set to 0. This step is used to initialize necessary variables for the new group associated with the logical address(es) carried in the host read command.
Step S862: It is determined whether the records associated with the group number “Grp” and the section number “Sec” have temporarily stored in the RAM 136. If so, the process proceeds to step S834. Otherwise, the process proceeds to step S864.
Step S864: The flash I/F 139 is driven to read the records associated with the group number “Grp” and the section number “Sec” from the H2F table in the flash module 150, and the records are stored in the designated address of the RAM 136. In addition, the variable “ReadSec_A” is increased by a total number of records in one section. For example, if a total number of records in one section is 256, then the variable “ReadSec_A” is increased by 256. It is noted that since only fixed space can be allocated in the RAM 136 to store records of the H2F table, when the allocated space is fully of records, the newly read record overwrites the earliest record stored in the RAM 136.

FIG. 9 shows a method for performing the operations of the section-mapping read mode 630 by the processing unit 134 when loading and executing program code of the FTL. The details are described as follows:
Step S922: The group number “Grp” and the section number “Sec” in the H2F table, which are associated with the logical address carried in the host read command, are obtained, and Hit_B-Usage_B/ReadSec_B is calculated, where the variable “Hit B” is used to store the actual hits in this batch. A portion of the details of this step is similar to that of step S710, and is omitted herein for brevity.
Step S924: If the records associated with the group number “Grp” and the section number “Sec” do not exist in the RAM 136, the flash I/F 139 is driven to read the records associated with the group number “Grp” and the section number “Sec” from the H2F table in the flash module 150, and the records are stored in the designated address of the RAM 136. It is noted that since only fixed space can be allocated in the RAM 136 to store records of the H2F table, when the allocated space is fully of records, the newly read record overwrites the earliest record stored in the RAM 136.
Step S941: It is determined whether the length of user data to be read, which is instructed by the host read command, is greater than or equal to the long-data threshold. If so, it needs a determination whether to leave the section-mapping read mode 630 and the subsequent operations, and the process proceeds to step S942. Otherwise, the whole process ends.
Step S942: It is determined whether the variable “Grp_B” is the same as the initial value. If so, the process proceeds to step S954. Otherwise, the process proceeds to step S944.
Step S944: It is determined whether the group number “Grp” is the same as the variable “Grp_B”. If so, it means that the group associated with the logical address(es) carried in the host read command is the same as the group associated with the latest record temporarily stored in the RAM 136, and the process proceeds to step S962. Otherwise, it means that the group associated with the logical address(es) carried in the host read command is different from the group associated with the latest record temporarily stored in the RAM 136 (that is, changing to a new group), and the process proceeds to step S946.
Step S946: It is determined whether the variable “Hit_B” is greater than the second hit threshold, where the second hit threshold can be set to an arbitrary value ranging from 0.6 to 0.9. In some embodiments, the second hit threshold is set to 0.7. If so, it means that the ratio indicating that the logical addresses carried in the host read commands in the previous batch hit the records temporarily stored in the RAM 136 meets the expectation (that is, the records temporarily stored in the RAM 136 are judged as the high-usage state), and the process proceeds to step S952. Otherwise, it means that the ratio indicating that the logical addresses carried in the host read commands in the previous batch hit the records temporarily stored in the RAM 136 does not meet the expectation (that is, the records temporarily stored in the RAM 136 are judged as the low-usage state), and the process proceeds to step S954.
Step S952: The variable “UsageHigherCnt” is increased by 1.
Step S954: The variable “Grp_B” is set to the group number “Grp”, the variable “Usage_B” is set to 0, and the variable “ReadSec_B” is set to the maximum number of records of the H2F table, which can be temporarily stored in the RAM 136, for example, 16×256=4096. This step is used to initialize necessary variables for the new group associated with the logical address(es) carried in the host read command.
Step S962: It is determined whether the variable “UsageLowerCnt” is greater than the accumulation threshold, and whether the variable “UsageHigherCnt” is greater than the accumulation threshold. If both are true, the process proceeds to step S964. Otherwise, the whole process ends.
Step S964: Relevant variables are initialized. Specifically, variables “UsageLowerCnt”, “UsageHigherCnt”, “ReadSec_A”, “Usage_A”, “ReadSec_B” and “Usage_B” are set to 0, and the variables “Grp_A” and “Grp_B” are set to initial values.

Although the invention is illustrated and described herein with reference to specific embodiments, the invention is not intended to be limited to the details shown. Rather, various modifications may be made in the details within the scope and range of equivalents of the claims and without departing from the invention. It is to be understood that the above description is illustrative of the invention and is not to be construed as limiting the invention. Various modifications, applications and/or combinations of the embodiments may occur to those skilled in the art without departing from the scope of the invention as defined by the claims.

One having ordinary skill in the art will readily understand that the invention as discussed above may be practiced with hardware elements in configurations which are different than those which are disclosed. Therefore, although the invention has been described based upon these preferred embodiments, it would be apparent to those skilled in the art that certain modifications, variations, and alternative constructions would be apparent, while remaining within the scope of the invention.

The present invention will be described with respect to particular embodiments and with reference to certain drawings, but the invention is not limited thereto and is only limited by the claims. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements. It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent.” etc.)

The term “device” or “module” is not limited to one or a specific number of physical objects (such as one smartphone, one controller, one processing system and so on). As used herein, a device may be any electronic device with one or more parts that may implement at least some portions of the invention in this disclosure. While the description and examples use the term “device” or “module” to describe various aspects of this disclosure, the term “device” or “module” is not limited to a specific configuration, type, or number of objects. Additionally, the term “system” or “module” is not limited to multiple components or specific aspects. For example, a system may be implemented on one or more printed circuit boards or other substrates and may have movable or static components. While the description and examples use the term “system” to describe various aspects of the invention in this disclosure, the term “system” is not limited to a specific configuration, type, or number of objects.

Specific details are provided in the description above to provide a thorough understanding of the aspects and examples provided herein. However, it will be understood by one of ordinary skills in the art that the aspects may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Some or all of the aforementioned embodiments of the method of the invention may be implemented in a computer program such as a driver for a dedicated hardware, a Firmware Translation Layer (FTL) of a storage device, or others. Other types of programs may also be suitable, as previously explained. Since the implementation of the various embodiments of the present invention into a computer program can be achieved by the skilled person using his routine skills, such an implementation will not be discussed for reasons of brevity. The computer program implementing some or more embodiments of the method of the present invention may be stored on a suitable computer-readable data carrier, or may be located in a network server accessible via a network such as the Internet, or any other suitable carrier.

A computer-readable storage medium includes volatile and non-volatile, removable and non-removable media implemented in any method or technology for storage of information such as computer-readable instruction, data structures, program modules, or other data. A computer-readable storage medium includes, but is not limited to, RAM, ROM, EEPROM, flash memory or other memory, CD-ROM, digital versatile disks (DVD), Blue-ray disk or other optical storage, magnetic cassettes, magnetic tape, magnetic disk or other magnetic storage devices, or any other medium which can be used to store the desired information and may be accessed by an instruction execution system. Note that a computer-readable medium can be paper or other suitable medium upon which the program is printed, as the program can be electronically captured via, for instance, optical scanning of the paper or other suitable medium, then compiled, interpreted, or otherwise processed in a suitable manner, if necessary, and then stored in a computer memory.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

The various illustrative logical blocks, modules, engines, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, engines, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

Although the embodiment has been described as having specific elements in FIGS. 1 to 3, it should be noted that additional elements may be included to achieve better performance without departing from the spirit of the invention. Each element of FIGS. 1 to 3 is composed of various circuits and arranged to operably perform the aforementioned operations. While the process flows described in FIGS. 7 to 9 include a number of operations that appear to occur in a specific order, it should be apparent that these processes can include more or fewer operations, which can be executed serially or in parallel (e.g., using parallel processors or a multi-threading environment).

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for accelerating execution of host read commands, comprising:
obtaining a first group number and a first section number associated with a logical address carried in a first host read command;
determining whether a first variable corresponding to a first mode is less than or equal to a first accumulation threshold, wherein the first variable stores a total number that mapping records temporarily stored in a random access memory (RAM) are judged as a low-usage state during the first mode;
when the first variable is less than or equal to the first accumulation threshold, performing operations of the first mode for reading a plurality of first records associated with the first group number and the first section number and a plurality of second records associated with the first group number and a second section number from a host-address to flash-address mapping (H2F) table in a flash module, and storing the first records and the second records in the RAM, wherein the first records store mapping information about which physical address where user data associated with each of a plurality of first logical addresses is actually stored in an order of the first logical addresses, the second records are located after the first records, and the second records store mapping information about which physical address where user data associated with each of a plurality of second logical addresses is actually stored in an order of the second logical addresses; and
when the first variable is greater than the first accumulation threshold, performing operations of a second mode for reading the first records associated with the first group number and the first section number from the H2F table in the flash module, and storing the first records in the RAM.

2. The method of claim 1, wherein the first accumulation threshold is set to 3.

3. The method of claim 1, further comprising:
obtaining a physical address mapped from the logical address from the first records in the RAM;
reading user data of the logical address carried in the first host read command from the physical address of the flash module; and
replying with the user data to a host side.

4. The method of claim 1, further comprising:
during the first mode, when the first group number is different from a second group number associated with a latest record temporarily stored in the RAM in the first mode, determining whether a second variable is less than a first hit threshold, wherein the second variable stores a ratio indicating that a logical address carried in a second host read command hits records temporarily stored in the RAM in a first batch in the first mode; and
when the second variable is less than the first hit threshold, increasing the first variable by 1.

5. The method of claim 4, wherein the first hit threshold is set to an arbitrary value ranging from 0.6 to 0.9.

6. The method of claim 4, wherein the second variable is calculated by an equation:
$$Hit\_ A = Usage\_ A / ReadSec \_ A$$
Hit_A represents the second variable, Usage_A represents a total number that at least one logical address carried in at least one host read command hits records temporarily stored in the RAM in the first batch in the first mode, ReadSec_A represents a total number of records that are read from the flash module in the first batch in the first mode.

7. The method of claim 1, further comprising:
during the second mode, when the first group number is different from a third group number associated with a latest record temporarily stored in the RAM in the second mode, determining whether a third variable is greater than a second hit threshold, wherein the third variable stores a ratio indicating that a logical address carried in a third host read command hits records temporarily stored in the RAM in a second batch in the second mode; and
when the third variable is greater than the second hit threshold, increasing a fourth variable by 1, wherein the fourth variable stores a total number that mapping records temporarily stored in the RAM are judged as a high-usage state during the second mode.

8. The method of claim 7, wherein the second hit threshold is set to an arbitrary value ranging from 0.6 to 0.9.

9. The method of claim 7, further comprising:
determining whether the first variable is greater than the first accumulation threshold and the fourth variable is greater than a second accumulation threshold, wherein the second accumulation threshold is set to an integer greater than 0; and
when the first variable is greater than the first accumulation threshold and the fourth variable is greater than a second accumulation threshold, setting the four variable to 0.

10. A non-transitory computer-readable storage medium having stored therein program code that, when loaded and executed by a processing unit, causes the processing unit to:
obtain a first group number and a first section number associated with a logical address carried in a first host read command;
determine whether a first variable corresponding to a first mode is less than or equal to a first accumulation threshold, wherein the first variable stores a total number that mapping records temporarily stored in a random access memory (RAM) are judged as a low-usage state during the first mode;
when the first variable is less than or equal to the first accumulation threshold, perform operations of the first mode for reading a plurality of first records associated with the first group number and the first section number and a plurality of second records associated with the first group number and a second section number from a host-address to flash-address mapping (H2F) table in a flash module, and storing the first records and the second records in the RAM, wherein the first records store mapping information about which physical address where user data associated with each of a plurality of first logical addresses is actually stored in an order of the first logical addresses, the second records are located after the first records, and the second records store mapping information about which physical address where user data associated with each of a plurality of second logical addresses is actually stored in an order of the second logical addresses; and
when the first variable is greater than the first accumulation threshold, perform operations of a second mode for reading the first records associated with the first group number and the first section number from the H2F table in the flash module, and storing the first records in the RAM.

11. The non-transitory computer-readable storage medium of claim 10, wherein the program code that, when loaded and executed by the processing unit, causes the processing unit to:
obtain a physical address mapped from the logical address from the first records in the RAM;
read user data of the logical address carried in the first host read command from the physical address of the flash module; and
reply with the user data to a host side.

12. The non-transitory computer-readable storage medium of claim 10, wherein the program code that, when loaded and executed by the processing unit, causes the processing unit to:
during the first mode, when the first group number is different from a second group number associated with a latest record temporarily stored in the RAM in the first mode, determine whether a second variable is less than a first hit threshold, wherein the second variable stores a ratio indicating that a logical address carried in a second host read command hits records temporarily stored in the RAM in a first batch in the first mode; and
when the second variable is less than the first hit threshold, increase the first variable by 1,
wherein the first hit threshold is set to an arbitrary value ranging from 0.6 to 0.9,
wherein the second variable is calculated by an equation:
$$Hit\_ A = Usage\_ A / ReadSec \_ A$$
Hit_A represents the second variable, Usage_A represents a total number that at least one logical address carried in at least one host read command hits records temporarily stored in the RAM in the first batch in the first mode, ReadSec_A represents a total number of records that are read from the flash module in the first batch in the first mode.

13. The non-transitory computer-readable storage medium of claim 10, wherein the program code that, when loaded and executed by the processing unit, causes the processing unit to:
when the first group number is different from a third group number associated with a latest record temporarily stored in the RAM in the second mode, determine whether a third variable is greater than a second hit threshold, wherein the third variable stores a ratio indicating that a logical address carried in a third host read command hits records temporarily stored in the RAM in a second batch in the second mode; and
when the third variable is greater than the second hit threshold, increase a fourth variable by 1, wherein the fourth variable stores a total number that mapping records temporarily stored in the RAM are judged as a high-usage state during the second mode,
wherein the second hit threshold is set to an arbitrary value ranging from 0.6 to 0.9.

14. The non-transitory computer-readable storage medium of claim 13, wherein the program code that, when loaded and executed by the processing unit, causes the processing unit to:
determine whether the first variable is greater than the first accumulation threshold and the fourth variable is greater than a second accumulation threshold, wherein the second accumulation threshold is set to an integer greater than 0; and;
when the first variable is greater than the first accumulation threshold and the fourth variable is greater than a second accumulation threshold, set the four variable to 0.

15. An apparatus for accelerating execution of host read commands, comprising:
a flash interface (I/F), coupled to a flash module, wherein the flash module is arranged operably to: store a host-address to flash-address mapping (H2F) table, the H2F table comprises a plurality of groups, each group comprises a plurality of sections, each section comprises a plurality of records, each record stores mapping information about which physical address where user data associated with each of a plurality of logical addresses is actually stored in an order of the logical addresses; and
a processing unit, coupled to the flash I/F, arranged operably to: obtain a first group number and a first section number associated with a logical address carried in a first host read command; determine whether a first variable corresponding to a first mode is less than or equal to a first accumulation threshold, wherein the first variable stores a total number that mapping records temporarily stored in a random access memory (RAM) are judged as a low-usage state during the first mode; when the first variable is less than or equal to the first accumulation threshold, perform operations of the first mode for driving the flash I/F to read a plurality of first records associated with the first group number and the first section number and a plurality of second records associated with the first group number and a second section number from the H2F table in the flash module, and storing the first records and the second records in the RAM, wherein the second records are located after the first records; and when the first variable is greater than the first accumulation threshold, perform operations of a second mode for driving the flash I/F to read the first records associated with the first group number and the first section number from the H2F table in the flash module, and storing the first records in the RAM.

16. The apparatus of claim 15, wherein the first accumulation threshold is set to an integer greater than 0.

17. The apparatus of claim 15, wherein the processing unit is arranged operably to: obtain a physical address mapped from the logical address from the first records in the RAM; drive the flash I/F to read user data of the logical address carried in the first host read command from the physical address of the flash module; and reply with the user data to a host side through a host I/F.

18. The apparatus of claim 15, wherein the processing unit is arranged operably to: during the first mode, when the first group number is different from a second group number associated with a latest record temporarily stored in the RAM in the first mode, determine whether a second variable is less than a first hit threshold, wherein the second variable stores a ratio indicating that a logical address carried in a second host read command hits records temporarily stored in the RAM in a first batch in the first mode; and when the second variable is less than the first hit threshold, increase the first variable by 1.

19. The apparatus of claim 18, wherein the first hit threshold is set to an arbitrary value ranging from 0.6 to 0.9.

20. The apparatus of claim 18, wherein the second variable is calculated by an equation:
$$Hit\_ A = Usage\_ A / ReadSec \_ A$$
Hit_A represents the second variable, Usage_A represents a total number that at least one logical address carried in at least one host read command hits records temporarily stored in the RAM in the first batch in the first mode, ReadSec_A represents a total number of records that are read from the flash module in the first batch in the first mode.

21. The apparatus of claim 15, wherein the processing unit is arranged operably to: during the second mode, when the first group number is different from a third group number associated with a latest record temporarily stored in the RAM in the second mode, determine whether a third variable is greater than a second hit threshold, wherein the third variable stores a ratio indicating that a logical address carried in a third host read command hits records temporarily stored in the RAM in a second batch in the second mode; and when the third variable is greater than the second hit threshold, increase a fourth variable by 1, wherein the fourth variable stores a total number that mapping records temporarily stored in the RAM are judged as a high-usage state during the second mode.

22. The apparatus of claim 21, wherein the second hit threshold is set to an arbitrary value ranging from 0.6 to 0.9.

23. The apparatus of claim 21, wherein the processing unit is arranged operably to: determine whether the first variable is greater than the first accumulation threshold and the fourth variable is greater than a second accumulation threshold, wherein the second accumulation threshold is set to an integer greater than 0; and when the first variable is greater than the first accumulation threshold and the fourth variable is greater than a second accumulation threshold, set the four variable to 0.
